(19) United States
(12) Patent Application Publication
(10) Pub. No.: US 2022/0100166 A1
(43) Pub. Date: Mar. 31, 2022

(54) ABNORMALITY MONITORING DEVICE AND ABNORMALITY MONITORING METHOD

(71) Applicant: HONGFUJIN PRECISION ELECTRONICS(TIANJIN)CO.,LTD., Tianjin (CN)

(72) Inventors: HSUEH-FANG AI, New Taipei (TW); MENG-CHU CHANG, New Taipei (TW); SHANG-YI LIN, New Taipei (TW)

(21) Appl. No.: 17/083,801

(22) Filed: Oct. 29, 2020

(30) Foreign Application Priority Data
Sep. 29, 2020 (CN) 202011057988.7

(51) Int. Cl. G05B 19/406; G06F 16/22; G06N 5/02

(52) U.S. Cl. CPC G05B 19/406; G06F 16/2282; G05B 2219/32194; G05B 2219/32368; G06N 5/022

(57) ABSTRACT

An abnormality monitoring method includes obtaining multiple target machine process parameters that affect a measurement value of a preset product at a first measurement point of the preset product, constructing a measurement value prediction model corresponding to the first measurement point, calculating a degree of fit of the measurement value prediction model, aggregating the degree of fit of the measurement value prediction model, the estimated value of the first measurement point, the target machine process parameters corresponding to the first measurement point, and the parameter coefficients of the target machine process parameters, repeating the above steps for each of multiple measurement points, calculating an influence degree index value of each machine, process parameter, and outputting warning information of machine process parameters that exceed a first preset influence degree index value.

### FIELD

The subject matter herein generally relates to an abnormality monitoring device and an abnormality monitoring method implemented by the abnormality monitoring device.

### BACKGROUND

In order to improve the yield and efficiency of product processing, it is of great importance to reduce the failure rate of the product processing equipment. Although some machines have the function of making physical automatic correction of some process parameters, it is often difficult to find the real abnormal process parameters.

### BRIEF DESCRIPTION OF THE DRAWINGS

Implementations of the present disclosure will now be described, by way of embodiments, with reference to the attached figures.

FIG. 1 is a schematic block diagram of an abnormality monitoring device according to an embodiment.

FIG. 2 is a functional block diagram of an abnormality monitoring program according to an embodiment.

FIG. 3 is a flowchart of an abnormal monitoring method according to an embodiment.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series, and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

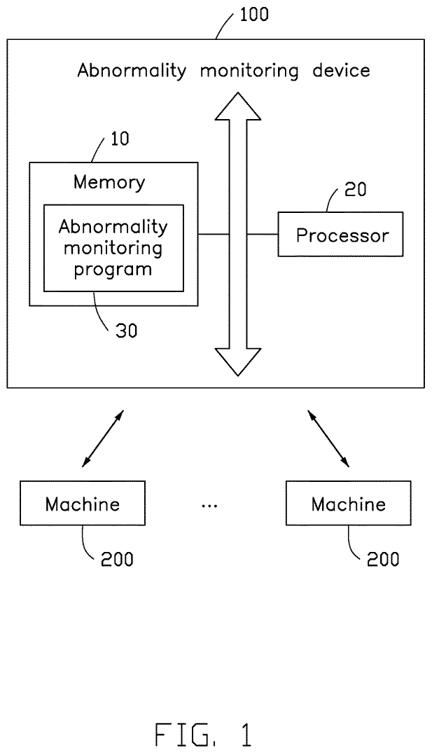

FIG. 1 shows a schematic diagram of an embodiment of an abnormality monitoring device 100.

The abnormality monitoring device 100 can monitor machine process parameters of one or more machines 200 to realize early detection of abnormal machine process parameters. The machine 200 may refer to a machine for processing parts and products, including but not limited to machine tools, numerical control equipment, industrial robots, etc. The machine process parameters may be parameters related to parts of the machine 200, such as a length of a tool, a rotation speed, and cutting parameters.

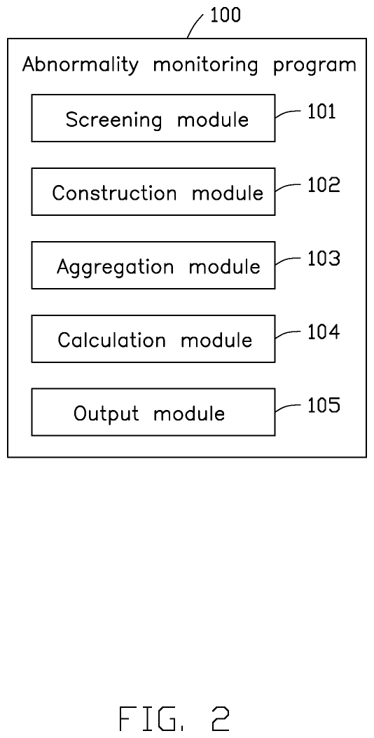

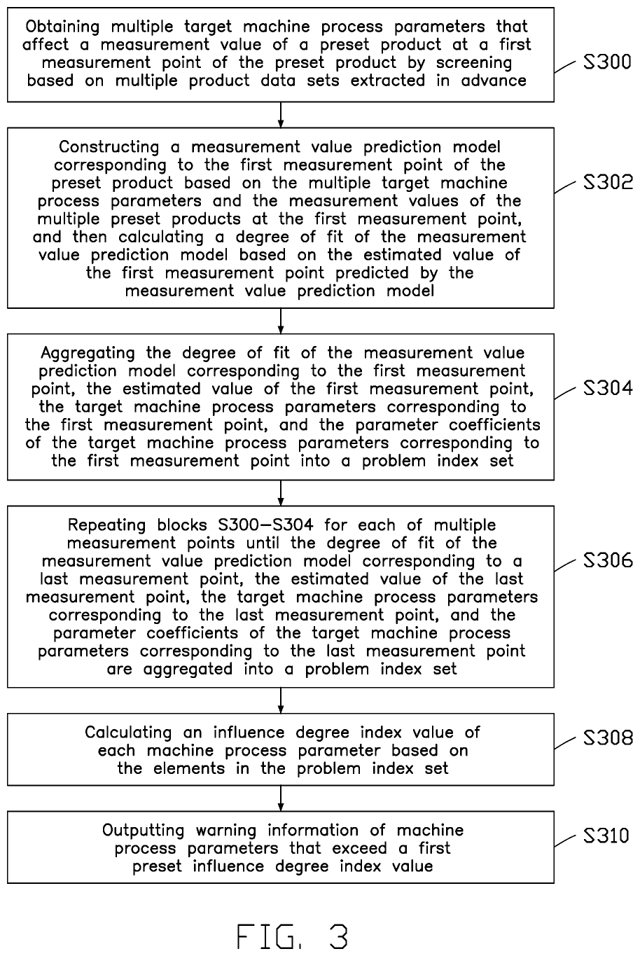

The abnormality monitoring device 100 may include a memory 10, a processor 20, and an abnormality monitoring program 30 stored in the memory 10 and executed by the processor 20. The processor 20 implements blocks of an abnormality monitoring method (shown in FIG. 3) when the abnormality monitoring program 30 is executed. Alternatively, when the processor 20 executes the abnormality monitoring program 30, functions of modules (shown in FIG. 2) are implemented.

The abnormality monitoring program 30 may be divided into one or more modules, and the one or more modules are stored in the memory 10 and executed by the processor 20. The one or more modules may be a series of computer program instruction segments capable of completing specific functions, and the instruction segments are used to describe the execution process of the abnormality monitoring program 30 in the abnormality monitoring device 100.

Those skilled in the art can understand that the schematic diagram is only an example of the abnormality monitoring device 100 and does not constitute a limitation on the abnormality monitoring device 100. In other embodiments, the abnormality monitoring device 100 may include more or less components than shown in the figures, combine certain components, or have different components. For example, the abnormality monitoring device 100 may also include an input display device, a bus, and the like.

The processor 20 may be a central processing unit, other general-purpose processors, digital signal processors, application specific integrated circuits, ready-made field-programmable gate arrays or other programmable logic devices, discrete gates or transistor logic devices, discrete hardware components, etc. The general-purpose processor may be a microprocessor or any processor known in the art. The processor 20 may use various interfaces and buses to connect various parts of the abnormality monitoring device 100.

The memory 10 can be used to store the abnormality monitoring program 30 and/or modules, and the processor 20 can implement the abnormality monitoring device 100 by running or executing the computer programs and/or modules stored in the memory 10 and calling data stored in the memory 10. The memory 10 may include a high-speed random access memory, and may also include a non-volatile memory, such as a hard disk, a memory, a plug-in hard disk, a smart media card, a secure digital card, a flash card, at least one magnetic disk storage device, flash memory device, or other volatile solid-state storage device.

Referring to FIG. 2, the abnormality monitoring program 30 may include a screening module 101, a construction module 102, an aggregation module 103, a calculation module 104, and an output module 105. In one embodiment, the aforementioned modules may be programmable software instructions that are stored in the memory 10 and executed by the processor 20. It can be understood that, in other implementation manners, the above-mentioned modules may also be program instructions or firmware in the processor 20.

The screening module 101 is used for screening and obtaining multiple target machine process parameters that affect a measurement value of a preset product at a first measurement point based on multiple product data sets extracted in advance.

In one embodiment, the machine 200 is used to process the preset product. The machine 200 includes p machine process parameters X₁-Xₚ, and p is a positive integer greater than 1. The preset product is set with N measurement points Y₁-Y_{N}. The N measurement points can be used to measure a same product parameters of the preset product, and N is a positive integer greater than 1. For example, the preset product is an LCD panel, and the preset product is set with N measurement points to measure a thickness of the panel. The multiple target machine process parameters are some or all of the multiple machine process parameters. For example, the multiple machine process parameters are Ω={X₁, X₂, X₃, . . . , Xₚ}, and the multiple target machine process parameters are {X′₁, X′₂, . . . , X′ₖ}; X′ₖ ∈ Ω; and k≤p.

Multiple product data sets correspond to multiple preset products. Each product data set includes p machine process parameters {X₁, X₂, X₃, . . . Xₚ} and the measurement value of the corresponding preset product at the first measurement point Y₁. It can be understood that for multiple preset products, the measurement value at the first measurement point Y₁ may be the same or different.

In one embodiment, data (such as XML format files) produced by the machine 200 for processing the preset product and measurement data of the preset product can be collected regularly or irregularly and stored manually or automatically in a designated storage area. Then, an ETL tool is used to extract designated data from the designated storage area and transfer the designated data to an analysis database, and then the abnormal machine process parameters can be found based on the analysis database. For example, the designated data may at least include the machine process parameters and the measurement values of the measurement points. The analysis database may include at least a first data table, a second data table, and a third data table. The first data table is used to store the multiple machine process parameters, the second data table is used to store the measurement values of the N measurement points, and the third data table is used to store a mapping relationship between the multiple machine process parameters and the measurement values of each of the measurement points.

In one embodiment, the ETL tool can extract the designated data from the designated storage area regularly or irregularly and transfer the extracted designated data to the analysis database. Multiple product data sets can be extracted from the analysis database.

In one embodiment, the screening module 101 can analyze multiple pre-extracted product data sets based on a preset screening rehearsal algorithm to screen and obtain multiple target machine process parameters that affect the measurement value of the preset product at the first measurement point. The preset screening rehearsal algorithm screens the target machine process parameters by determining a difference degree index of a combination of multiple machine process parameters. The difference degree index can include a mean-squared error (MSE), and the MSE reflects a degree of difference between an actual quantity and an estimated quantity. For the screening of target machine process parameters, it is better to have a smaller difference degree index and fewer machine process parameters.

For example, there are ten machine process parameters {X₁, X₂, X₃, . . . , X₁₀}. By permuting and combining the ten machine process parameters, multiple machine process parameter sets can be obtained. Each machine process parameter set may include at least one machine process parameter, and the difference degree index value of each machine process parameter set is determined according to the difference between the actual value of the first measurement point and the estimated value of the first measurement point. For multiple preset products, if there are one or more differences in the measurement values at the first measurement point, an average value of the measurement values at the first measurement point is first calculated, and then the difference between the average value at the first measurement point and the estimated value at the first measurement point of each machine process parameter set is calculated. For example, a first machine process parameter set {X₁, X₂} has a difference degree index value of 0.3, a second machine process parameter set {X₁, X₂, X₃} has a difference degree index value of 0.7, a third machine process parameter set {X₂, X₄, X₇} has a difference degree index value of is 0.1, and a fourth machine process parameter set {X₂, X₄, X₇, X₉} has a difference degree index value of 0.1. The third machine process parameter set and the fourth machine process parameter set have a lowest difference degree index value of 0.1. Because the third machine process parameter set has fewer elements than the fourth machine process parameter set, the third machine process parameter set {X₂, X₄, X₇} is defined as the target machine process parameters.

The construction module 102 is configured to construct a measurement value prediction model M1 corresponding to the first measurement point based on the multiple target machine process parameters and the measurement values of the multiple preset products at the first measurement point, and then calculate a degree of fit of the measurement value prediction model M1 based on the estimated value of the first measurement point predicted by the measurement value prediction model M1.

In one embodiment, the multiple target machine process parameters are machine process parameters that can more accurately predict the measurement value of the first measurement point. The measurement value prediction model M1 may be a linear model. The measurement value prediction model M1 can calculate the estimated value of the first measurement point according to each target machine process parameter and a parameter coefficient corresponding to each target machine process parameter.

In one embodiment, the construction module 102 may construct the measurement value prediction model M1 corresponding to the first measurement point based on multiple target machine process parameters and multiple measurement values of the preset product at the first measurement point. For example, the multiple target machine process parameters are the machine process parameters {X₂, X₄, X₇}, and the measurement value prediction model M1 of the first measurement point is Y₁=a*X₂+b*X₄+c*X₇. The construction module 102 can perform regression analysis based on the parameter values of the target machine process parameters {X₂, X₄, X₇} and the measurement values of the first measurement point of the preset product to determine values of the parameter coefficients a, b, c. After determining the values of the parameter coefficients a, b, and c, the set of parameter values of the machine process parameters {X₂, X₄, X₇} can be input into the measurement value prediction model M1, and the estimated value of the first measurement point corresponding to the set of parameter values can be calculated.

Further, the estimated value of the first measurement point calculated by the measurement value prediction model M1 and the actual value of the first measurement point are used to calculate a degree of fit Rs1 of the measurement value prediction model M1.

In one embodiment, multiple linear models can be constructed in advance, and the construction module 102 can select a suitable linear model according to a model index of each linear, model to construct the measurement value prediction model M1 corresponding to the first measurement point. The model index may include mean absolute error (MAE), mean squared error (MSE), and root mean squared error (RMSE).

In one embodiment, since the linear model generally outputs a one-dimensional value, when each of the N measurement points contains measurement values of multiple dimensions, a preset dimensionality reduction function can be used to map the measurement value of each measurement point to a one-dimensional value. For example, the measurement value of the first measurement point is deviation values Z₁, Z₂, and Z₃ in three dimensions. The preset dimensionality reduction function may be g(x), g(x)=\sqrt{Z₁²+Z₂²+Z₃²}. After the measurement value of the first measurement point is reduced to one dimension, the construction module 102 constructs the measurement based on the multiple target machine process parameters and the measurement value prediction model M1 based on the multiple target machine process parameters and the measurement values at the first measurement point of the multiple preset products.

The aggregation module 103 is used to aggregate the degree of fit of the measurement value prediction model M1 corresponding to the first measurement point, the estimated value of the first measurement point, the target machine process parameters corresponding to the first measurement point, and the parameter coefficients of the target machine process parameters corresponding to the first measurement point into a problem index set.

For example, the measurement value prediction model M1 corresponding to the first measurement point is Y₁=0.2*X₂+0.3*X₄+0.1*X₇, and the degree of fit of the measurement value prediction model M1 corresponding to the first measurement point is Rs1. The estimated value of the first measurement point is the estimated value calculated by the measurement value prediction model M1. The target machine process parameters corresponding to the first measurement point are {X₂, X₄, X₇}, and the parameter coefficients of the target machine process parameters corresponding to the first measurement point are {0.2, 0.3, 0.1}.

It can be understood that for the second measurement point, the same processing method as that of the first measurement point is used to obtain a measurement value prediction model M2 corresponding to the second measurement point. The aggregation module 103 can aggregate the degree of fit of the measurement value prediction model M2 corresponding to the second measurement point, the estimated value of the second measurement point, the target machine process parameters corresponding to the second measurement point, and the parameter coefficients of the target machine process parameters corresponding to the second measurement point into a problem index set. For the Nth measurement point, the same processing method as the above-mentioned first measurement point can also be adopted to obtain a measurement value prediction model MN corresponding to the Nth measurement point. The aggregation module 103 can aggregate the degree of fit of the measurement value prediction model MN corresponding to the Nth measurement point, the estimated value of the Nth measurement point, the target machine process parameters corresponding to the Nth measurement point, and the parameter coefficients of the target machine process parameters corresponding to the Nth measurement point into a problem index set.

The calculation module 104 is configured to calculate an influence degree index value of each machine process parameter based on the elements in the problem index set.

In one embodiment, the influence degree index value reflects an amount of influence of the corresponding machine process parameter that affects the machine 200 to process the preset product. When the calculated influence degree index value is larger, the corresponding machine process parameter has more influence, or the corresponding machine process parameter may be abnormal. The calculation module 104 may select a preset conversion function and the elements in the problem index set to calculate the influence degree index value of each machine process parameter.

For example, taking ten machine process parameters {X₁, X₂, X₃, . . . , X₁₀} and five measurement points {Y₁, Y₂, Y₃, . . . , Y₅} as an example for illustration, the screening module 101 screens and obtains the target machine process parameters that influence the measurement values of the five measurement points of the preset product as shown in Table 1 below.

TABLE 1

| | Y₁ | Y₂ | Y₃ | Y₄ | Y₅ |
|---|---|---|---|---|---|
| X₁ | | | | V | |
| X₂ | V | | V | | V |
| X₃ | | V | | | |
| X₄ | | V | | | |
| X₅ | | | | | |
| X₆ | V | | V | V | V |
| X₇ | | V | V | | |
| X₈ | | | | | |
| X₉ | | | | | |
| X₁₀ | | | | | |

As shown in Table 1, the target machine process parameters corresponding to the first measurement point Y₁ are the machine process parameters X₂ and X₆. The target machine process parameters corresponding to the second measurement point Y₂ are the machine process parameters X₃, X₄, X₇. The target machine process parameters corresponding to the fifth measurement point Y5 are the machine process parameters X₂ and X₆. After constructing the measurement value prediction models M1-M5 corresponding to the measurement points Y₁-Y₅, a linear model is established corresponding to each measurement point or the target machine process parameter corresponding to each measurement point, and then the R-squared coefficients are stored as shown in Table 2 below.

TABLE 2

| | Y₁ | Y₂ | Y₃ | Y₄ | Y₅ |
|---|---|---|---|---|---|
| X₁ | 0 | 0 | 0 | 0.08 | 0 |
| X₂ | 0.43 | 0 | 0.28 | 0 | 0.22 |
| X₃ | 0 | 0.001 | 0 | 0 | 0 |
| X₄ | 0 | 0.01 | 0 | 0 | 0 |
| X₅ | 0 | 0 | 0 | 0 | 0 |
| X₆ | 0.1 | 0 | 0.23 | 0.37 | 0.2 |
| X₇ | 0 | 0.1 | 0.11 | 0 | 0 |
| X₈ | 0 | 0 | 0 | 0 | 0 |
| X₉ | 0 | 0 | 0 | 0 | 0 |
| X₁₀ | 0 | 0 | 0 | 0 | 0 |

As shown in Table 2, a linear model established based on X₂ and Y₁ has an R-squared value of 0.43, and a linear model established based on X₆ and Y₁ has an R-squared value of 0.1, and then store 0.1 in the corresponding column of Table 2. For the other machine process parameters that are not the target machine process parameters corresponding to the measurement points, the R-squared value is 0.

It can be understood that the R-squared value is the corresponding coefficient of determination for linear models. If the measurement value prediction model is not a linear model, the corresponding coefficient of determination may be another coefficient of determination.

The calculation module 104 can obtain the influence degree index value of each machine process parameter based on a number of times each machine process parameter appears in Table 2, the R-squared values of each machine process parameter, and the parameter coefficient of each machine process parameter, as shown in Table 3 below. In actual situations, for each machine process parameter, there may be multiple influence degree index values.

TABLE 3

| | Y₁ | Y₂ | Y₃ | Y₄ | Y₅ | Influence degree index value |
|---|---|---|---|---|---|---|
| X₁ | 0 | 0 | 0 | 0.08 | 0 | 0.080 |
| X₂ | 0.43 | 0 | 0.28 | 0 | 0.22 | 1.597 |
| X₃ | 0 | 0.001 | 0 | 0 | 0 | 0.001 |
| X₄ | 0 | 0.01 | 0 | 0 | 0 | 0.010 |
| X₅ | 0 | 0 | 0 | 0 | 0 | 0 |
| X₆ | 0.1 | 0 | 0.23 | 0.37 | 0.2 | 1.582 |
| X₇ | 0 | 0.1 | 0.11 | 0 | 0 | 0.398 |
| X₈ | 0 | 0 | 0 | 0 | 0 | 0 |
| X₉ | 0 | 0 | 0 | 0 | 0 | 0 |
| X₁₀ | 0 | 0 | 0 | 0 | 0 | 0 |

As shown in Table 3 above, the machine process parameter X₁ only appears once, the R-squared value of the machine process parameter X₁ is 0.08, and the influence degree index value of the machine process parameter X₁ is 0.08. The machine process parameter X₂ appears three times, the corresponding R-squared values of the machine process parameter X₂ are 0.43, 0.28, 0.22, and the influence degree index value of the machine process parameter X₂ is 1.597. The process parameter X₅ appears zero times, so the influence degree index value of the machine process parameter X₅ is 0. The machine process parameter X₇ appears two times, the R-squared values corresponding to the machine process parameter X₇ are 0.1 and 0.11, and the influence degree index value of the machine process parameter X₇ is 0.398. The preset conversion function is set based on the number of occurrences of the machine process parameter and the degree to which the machine process parameter affects the measurement value.

The output module 105 is configured to output warning information of machine process parameters that exceed a first preset influence degree index value.

In one embodiment, the first preset influence degree index value can be set and adjusted according to actual needs. For example, the first preset impact index value is set to 1.0, then in Table 3, the output module 105 outputs the warning information of the machine process parameters X₂ and X₆ to prompt a machine operator to perform machine maintenance in time. For example, the warning information of the machine process parameters X₂ and X₆ can be output on a display device of the abnormality monitoring device 100.

In one embodiment, multiple preset conversion methods may be used to convert the number of occurrences of each machine process parameter in the problem index set and the parameter coefficient of each machine process parameter to obtain multiple influence degree index values of each machine process parameter. When there are multiple influence degree index values of the machine process parameters that exceed the first preset influence degree index value, an aggregation machine abnormality index may be output. The aggregation machine abnormality index can be used to describe the degree of abnormality of each of the machine process parameters of each machine, so that the machine operator can easily understand the cause and degree of the abnormality. For example, the aggregate machine abnormality index indicates an abnormality caused by a machined part of the machine 200.

FIG. 3 is a flowchart of an abnormality monitoring method according to an embodiment. According to different requirements, the order of blocks in the flowchart can be changed, and some blocks can be omitted or combined.

In block S300, multiple target machine process parameters that affect a measurement value of a preset product at a first measurement point of the preset product are obtained by screening based on multiple product data sets extracted in advance.

In block S302, a measurement value prediction model corresponding to the first measurement point of the preset product is constructed based on the multiple target machine process parameters and the measurement values of the multiple preset products at the first measurement point, and then a degree of fit of the measurement value prediction model based on the estimated value of the first measurement point predicted by the measurement value prediction model is calculated.

In block S304, the degree of fit of the measurement value prediction model corresponding to the first measurement point, the estimated value of the first measurement point, the target machine process parameters corresponding to the first measurement point, and the parameter coefficients of the target machine process parameters corresponding to the first measurement point are aggregated into a problem index set.

In block S306, blocks S300-S304 are repeated for each of a multiple of measurement points until the degree of fit of the measurement value prediction model corresponding to a last measurement point, the estimated value of the last measurement point, the target machine process parameters corresponding to the last measurement point, and the parameter coefficients of the target machine process parameters corresponding to the last measurement point are aggregated into a problem index set.

In block S308, an influence degree index value of each machine process parameter is calculated based on the elements in the problem index set.

In block S310, warning information of machine process parameters that exceed a first preset influence degree index value is output.

The above-mentioned abnormal monitoring device, method and computer-readable storage medium for machine process parameters use multi-point measurement data and machine process data to construct and analyze problem index sets to find abnormal machine process parameters as soon as possible. Reduce machine downtime and improve process quality.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An abnormality monitoring method for monitoring multiple machine process parameters, the multiple machine process parameters used for processing multiple preset products, the preset products set with N measurement points, the N measurement points used for measuring a same product parameter of the preset product, N being a positive integer greater than 1, the abnormality monitoring method comprising:
obtaining multiple target machine process parameters that affect a measurement value of the preset product at a first measurement point of the preset product by screening based on multiple product data sets extracted in advance, wherein the multiple target machine process parameters are some or all of the machine process parameters, the multiple product data sets correspond to the multiple preset products, and each product data set comprises multiple machine process parameters and corresponding measurement values of the preset product at the first measurement point;
constructing a measurement value prediction model corresponding to the first measurement point based on the multiple target machine process parameters and the measurement values of the multiple preset products at the first measurement point, and then calculating a degree of fit of the measurement value prediction model based on the estimated value of the first measurement point predicted by the measurement value prediction model, wherein the measurement value prediction model calculates the estimated value of the first measurement point according to each target machine process parameter and a parameter coefficient corresponding to each target machine process parameter;
aggregating the degree of fit of the measurement value prediction model corresponding to the first measurement point, the estimated value of the first measurement point, the target machine process parameters corresponding to the first measurement point, and the parameter coefficients of the target machine process parameters corresponding to the first measurement point into a problem index set;
repeating the above steps for each of the multiple measurement points until the degree of fit of the measurement value prediction model corresponding to the Nth measurement point, the estimated value of the Nth measurement point, the target machine process parameters corresponding to the Nth measurement point, and the parameter coefficients of the target machine process parameters corresponding to the Nth measurement point are aggregated into a problem index set;
calculating an influence degree index value of each machine process parameter based on the elements in the problem index set; and
outputting warning information of machine process parameters that exceed a first preset influence degree index value.

2. The abnormality monitoring method of claim 1, further comprising:
collecting machine processing parameters for processing the preset product and measurement parameters of the preset product; and
extracting designated data from the collected machine processing parameters and storing the extracted designated data to an analysis database; wherein:
the analysis database comprises at least a first data table, a second data table, and a third data table;
the first data table is used to store the multiple machine process parameters;
the second data table is used to store the measurement values of the N measurement points;
the third data table is used to store a mapping relationship between the multiple machine process parameters and the measurement values of each of the measurement points; and
the product data sets are extracted from the analysis database.

3. The abnormality monitoring method of claim 2, wherein:
the multiple machine process parameters and the measurement values are extracted by a preset ETL tool.

4. The abnormality monitoring method of claim 1, wherein before the step of constructing a measurement value prediction model corresponding to the first measurement point based on the multiple target machine process parameters and the measurement values of the multiple preset products at the first measurement point, the method further comprising:
if the measurement value of the first measurement point comprises multiple dimension values, mapping the measurement value of the first measurement point to a one-dimensional value by using a preset dimensionality reduction function.

5. The abnormality monitoring method of claim 1, wherein:
the measurement value prediction model is a linear model.

6. The abnormality monitoring method of claim 5, wherein:
the linear model comprises multiple linear coefficients; and
the parameter coefficients of the multiple target machine process parameters and the multiple linear coefficients correspond one-to-one.

7. The abnormality monitoring method of claim 1, wherein:
the influence degree index value of each machine process parameter based on the elements in the problem index set is calculated based on the number of occurrences of the machine process parameter and the parameter coefficient of each machine process parameter.

8. The abnormality monitoring method of claim 7, further comprising:
using multiple preset conversion methods to convert the number of occurrences of each machine process parameter in the problem index set and the parameter coefficient of each machine process parameter to obtain multiple influence degree index values of each machine process parameter; and
when there are multiple influence degree index values of the machine process parameters that exceed the first preset influence degree index value, outputting an aggregation machine abnormality index; wherein:
the aggregation machine abnormality index describes the degree of abnormality of each of the machine process parameters.

9. An abnormality monitoring device for monitoring multiple machine process parameters of a machine, the multiple machine process parameters used for processing multiple preset products, the preset products set with N measurement points, the N measurement points used for measuring a same product parameter of the preset product, N being a positive integer greater than 1, the abnormality monitoring device comprising:
a processor; and
a memory storing a plurality of instructions, which when executed by the processor, cause the processor to:
obtain multiple target machine process parameters that affect a measurement value of the preset product at a first measurement point of the preset product by screening based on multiple product data sets extracted in advance, wherein the multiple target machine process parameters are some or all of the machine process parameters, the multiple product data sets correspond to the multiple preset products, and each product data set comprises multiple machine process parameters and corresponding measurement values of the preset product at the first measurement point;
construct a measurement value prediction model corresponding to the first measurement point based on the multiple target machine process parameters and the measurement values of the multiple preset products at the first measurement point, and then calculate a degree of fit of the measurement value prediction model based on the estimated value of the first measurement point predicted by the measurement value prediction model, wherein the measurement value prediction model calculates the estimated value of the first measurement point according, to each target machine process parameter and a parameter coefficient corresponding to each target machine process parameter;
aggregate the degree of fit of the measurement value prediction model corresponding to the first measurement point, the estimated value of the first measurement point, the target machine process parameters corresponding to the first measurement point, and the parameter coefficients of the target machine process parameters corresponding to the first measurement point into a problem index set;
repeat the above steps for each of the multiple measurement points until the degree of fit of the measurement value prediction model corresponding to the Nth measurement point, the estimated value of the Nth measurement point, the target machine process parameters corresponding to the Nth measurement point, and the parameter coefficients of the target machine process parameters corresponding to the Nth measurement point are aggregated into a problem index set;
calculate an influence degree index value of each machine process parameter based on the elements in the problem index set; and
output warning information of machine process parameters that exceed a first preset influence degree index value.

10. The abnormality monitoring device of claim 9, wherein the processor is further configured to:
collect machine processing parameters for processing the preset product and measurement parameters of the preset product; and
extract designated data from the collected machine processing parameters and store the extracted designated data to an analysis database; wherein:
the analysis database comprises at least a first data table, a second data table, and a third data table;
the first data table is used to store the multiple machine process parameters;
the second data table is used to store the measurement values of the N measurement points;
the third data table is used to store a mapping relationship between the multiple machine process parameters and the measurement values of each of the measurement points; and
the product data sets are extracted from the analysis database.

11. The abnormality monitoring device of claim 10, wherein:
the multiple machine process parameters and the measurement values are extracted by a preset ETL tool.

12. The abnormality monitoring, device of claim 9, wherein before the processor constructs a measurement value prediction model corresponding to the first measurement point based on the multiple target machine process parameters and the measurement values of the multiple preset products at the first measurement point, the processor is further configured to:
if the measurement value of the first measurement point comprises multiple dimension values, map the measurement value of the first measurement point to a one-dimensional value by using a preset dimensionality reduction function.

13. The abnormality monitoring device of claim 9, therein:
the measurement value prediction model is a linear model.

14. The abnormality monitoring device of claim 13, wherein:
the linear model comprises multiple linear coefficients; and
the parameter coefficients of the multiple target machine process parameters and the multiple linear coefficients correspond one-to-one.

15. The abnormality monitoring device of claim 9, wherein:
the influence degree index value of each machine process parameter based on the elements in the problem index set is calculated based on the number of occurrences of the machine process parameter and the parameter coefficient of each machine process parameter.

16. The abnormality monitoring device of claim 15, wherein the processor is further configured to:
use multiple preset conversion methods to convert the number of occurrences of each machine process parameter in the problem index set and the parameter coefficient of each machine process parameter to obtain multiple influence degree index values of each machine process parameter; and
when there are multiple influence degree index values of the machine process parameters that exceed the first preset influence degree index value, output an aggregation machine abnormality index; wherein:
the aggregation machine abnormality index describes the degree of abnormality of each of the machine process parameters.
